(19) United States
(12) Patent Application Publication
(10) Pub. No.: US 2002/0138575 A1
(43) Pub. Date: Sep. 26, 2002

(54) Multicast system

(76) Inventor: Katsumi Hirata, Kawasaki-shi (JP)

Correspondence Address: KATTEN MUCHIN ZAVIS ROSENMAN, 575 MADISON AVENUE, NEW YORK, NY, 10022-2585, US

(21) Appl. No.: 09/921,337

(22) Filed: Aug. 2, 2001

(30) Foreign Application Priority Data
Mar. 26, 2001 (JP) 2001-087414

(51) Int. Cl. G06F 15/16; G09G 5/00

(52) U.S. Cl. 709/205; 345/753

(57) ABSTRACT

A client, when desiring to multicast the data, transmits the data and destination information on a plurality of transmission destinations to a center system. The center system generates a multicast group containing the plurality of transmission destinations on the basis of the destination information, and multicasts the data to the generated multicast group.

### BACKGROUND OF THE INVENTION

1. Field of the Invention

The present invention relates to a system for multicasting the data.

2. Description of the Related Art

In the case of distributing a content having a large capacity to a multiplicity of terminals, the following conventional methods have hitherto been adopted.

(1) The content is distributed to the terminals one by one, which requires a comparatively long time.

(2) The content is distributed by utilizing a broadcast function as through satellite communications etc.

TCP/IP (Transmission control Protocol/Internet Protocol) has been adopted as a protocol in a multiplicity of networks over the recent years. Further, IP multicast is standardized as a function of multicasting IP packets in the IP network. It is therefore considered that a spread of services utilizing the IP multicast will be speeded up.

The IP multicast is defined as a function of simultaneously distributing information to a multicast group into which transmission target destinations (addresses) are grouped by making use of multicast addresses. Generally, the IP multicast is used for distributing the data to a multiplicity of (specified) clients from a center system by a push type information distribution (push technology). For instance, in-office divisions are linked via an Intranet, and information given from a certain division is multicast via the Intranet to a plurality of other divisions from a center system (a transmission center)

According to the prior art, the data are multicast batchwised by the transmission center. Therefore, the multicast groups are registered beforehand in the data transmission center. Accordingly, the multicast can not be used unless the multicast groups are registered beforehand.

Further, a process of generating the multicast group is assigned exclusively to a center operator who operates the transmission center, and users (clients) of the multicast are unable to generate the multicast groups as they intend by operating the transmission center. Note that though the center operator has ever registered the multicast group by a remote operation from a different site, this simply implies that an operation site of the center operator changes but does not mean that the operation is done off an operation area of the center operator.

On the other hand, it is desirable that the client be able to arbitrarily select the transmission destinations and able to transmit the data. The client is, however, unable to generate a multicast group as the client intends, and, when desiring to multicast a certain set of data to a plurality of transmission destinations, sends the data to the center operator and requests the center operator to register the plurality of transmission destinations as a multicast group.

In the case of multicasting the data, a plurality of IP addresses corresponding to the transmission destinations are grouped by allocating a multicast address thereto. Therefore, if the multicast group changes each time, or if a new IP address is added to the existing multicast group, the center operator must register or change the multicast group as the necessity arises. These operations are considerably troublesome to the center operator.

Thus, it is time-consuming for the client to request the center operator to multicast by specifying the transmission data and the transmission destinations, and it is also time-consuming for the center operator to register or change the multicast group in response to the request given from the client. Accordingly, the client was substantially unable to select the data distributing destinations as the client intends. This hinders user-friendliness in multicasting.

Moreover, a method that can be considered in the case of multicasting the information from a plurality of terminals, is that center server system s(center systems) each having the multicast function are installed in all those terminals. This method is, however, ruled out of its utilization in terms of a rise in cost and a complicated architecture of the system.

### SUMMARY OF THE INVENTION

It is a primary object of the present invention to provide a multicast system capable of selecting a plurality of transmission destinations on side of a client as the client intends.

It is another object of the present invention to provide a multicast system capable of reducing a load on an operator of a center system for multicasting the data.

To accomplish the above objects, according to one aspect of the present invention, a multicast system comprises a client, and a center system connected via a network to the client. The client includes a data transmission module for transmitting to the center system pieces of data that should be multicast, and a destination information notifying module for notifying the center system of destination information on a plurality of transmission destinations of the data. The center system includes a receiving module for receiving the data and the destination information, a generating module for generating a multicast group containing the plurality of transmission destinations on the basis of the destination information, and a multicast module for multicasting the data to the generated multicast group.

According to the present invention, the center system generates the multicast group based on the destination information. Therefore, the client has no necessity of requesting a center operator to register the multicast group as done in the prior art. Further, the center operator does not have a necessity of registering the multicast group.

There appear recently services that utilize streaming for reproducing pictures and sounds in realtime while downloading these contents distributed by multicasting. The present invention can be applied to both of a data file distribution and a stream data distribution.

According to the present invention, the client is able to select the plurality of transmission destinations as the client desires.

Further, according to the present invention, it is feasible to relieve the load upon the operator of the center system for multicasting the data.

### BRIEF DESCRIPTION OF THE DRAWINGS

FIG. 1 is a view showing a system architecture in a first embodiment;

FIG. 2 is a diagram showing a hardware architecture of a center system;

FIG. 3 is a diagram showing a hardware architecture of a client;

FIG. 4 is an explanatory diagram showing an operational example in the first embodiment;

FIG. 5 is an explanatory diagram showing a modified example of the first embodiment;

FIG. 6 is an explanatory diagram showing an identification information database;

FIG. 7 is a diagram showing a display example of a list screen (client screen);

FIG. 8 is an explanatory diagram showing an operational example in a second embodiment; and

FIG. 9 is a view showing a system architecture in a third embodiment.

### DESCRIPTION OF THE PREFERRED EMBODIMENTS

Embodiments of the present invention will hereinafter be described with reference to the accompanying drawings. Each of the following embodiments is given as exemplification, and the present invention is not limited to architectures in the embodiments.

[First Embodiment]

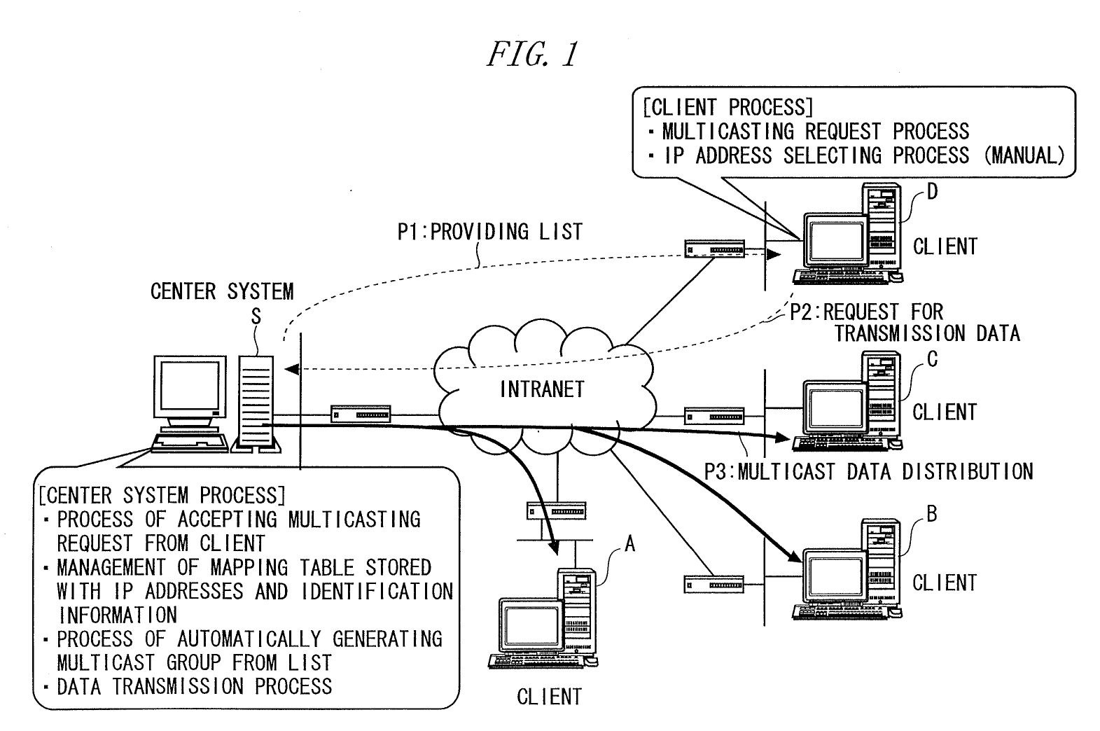

FIG. 1 is a view showing a system architecture in a first embodiment. The system is categorized as an in-office network (Intranet) system used for in-office communications of information. According to this system, a client (user) is a prime mover for generating a multicast group.

Referring to FIG. 1, the system includes a center device (which may be called a [center gateway]) S and a plurality of client devices (client devices A˜D are illustrated in FIG. 1 and may simply be called [clients]).

The center system S and the clients A˜D are connected via routers to the Internet (corresponding to a network), whereby each f the clients A˜D is connected to the network to the center system S. The center system S is installed in a predetermined in-office position. Each of the clients A˜D is installed in, e.g., every business office of an enterprise (company).

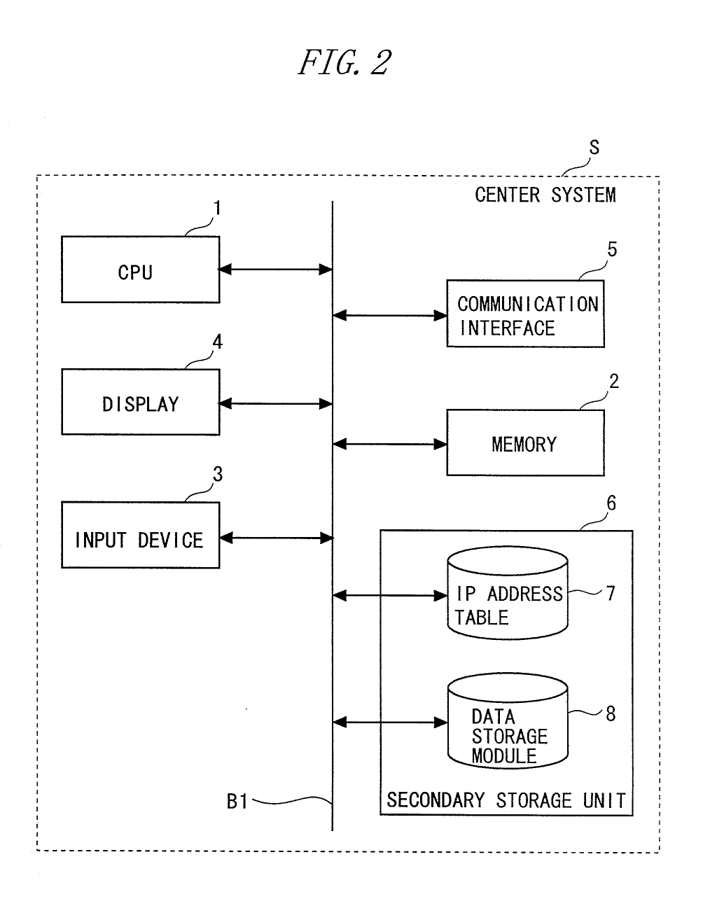

FIG. 2 is a diagram showing a hardware architecture of the center system S. Referring to FIG. 2, the center system S is a computer including a CPU 1, a memory 2, an input device 3, a display 4, a communication interface (I/F) 5 and a secondary storage unit 6, which are connected to each other via a bus B1.

The secondary storage unit 6 is constructed by use of, e.g., a hard disk. An IP address table 7 and a data storage module 8 are provided on the secondary storage unit 6. The data storage module 8 is stored with data files that are received from the clients A˜D and should be multicast by the center systems. The IP address table 7 is stored with a mapping between a set of a plurality of IP addresses registerable as a multicast group and another set of site names.

The secondary storage unit 6 is recorded with a plurality of programs executed by the CPU 1 and plural items of data used when executing these programs. The plurality of programs include a program for the computer to execute a plurality of processes so as to function as the center system S, and programs for actualizing communication protocols (TCP/IP (Transmission Control Protocol/Internet Protocol, HTTP (HyperText Transfer Protocol, FTP (File Transfer Protocol), SMTP (Simple Mail Transfer Protocol), POP (Post Office Protocol), etc) with the clients A˜D.

The input device 13 is constructed of a keyboard and a pointing device and used for an operator (center operator) to input data and commands. The pointing device is, for example, a mouse, a trackball, a joystick and a flat point.

The display 4 involves the use of, e.g., a CRT, an LCD, a plasma display etc. The display 4 displays the data and the commands inputted by the input device 13, and also a result of executing the program by the CPU 1.

The communication interface 5 controls a transmitting/receiving process of the data between the center system S and the clients A˜D. The memory 2 functions as a work area and a video memory.

The CPU 1 downloads the respective programs stored in the secondary storage unit 6 into the memory 2 and executes the programs, whereby the computer functions as the center system S. The processes executed by the CPU 1 include a process of creating the IP address table 7 on the secondary storage unit 6, a process of storing the data storage module 8 with the files obtained from the clients, a process of obtaining pieces of information for creating the multicast group from the clients A˜D, a process of creating the multicast group, and a process of multicasting the files in the data storage module 8 to the multicast group.

Note that the CPU 1 and the communication I/F 5 correspond to a receiving module, a distribution module and a list providing module according to the present invention, and the CPU 1 also corresponds to a generating module according to the present invention.

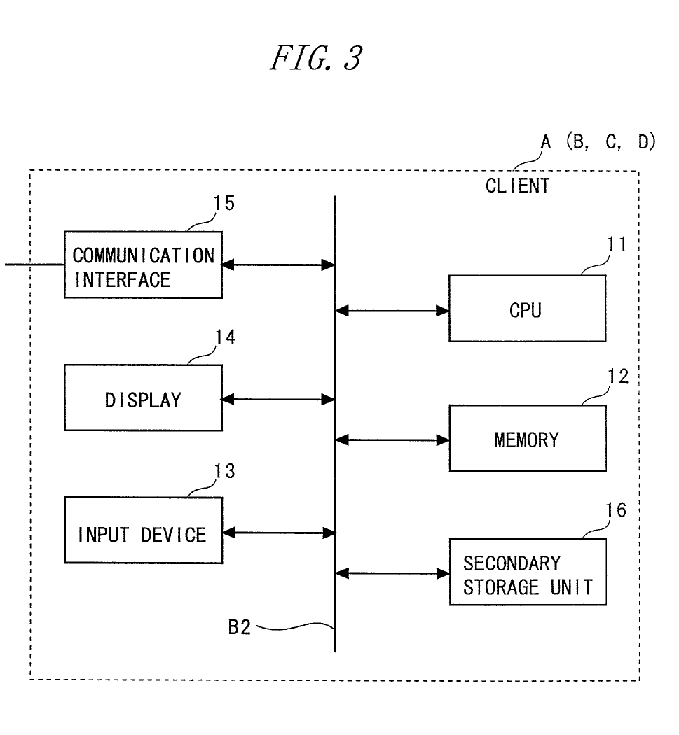

FIG. 3 is a diagram showing an example of a hardware architecture of each of the clients A˜D. The plurality of clients A˜D has the same architecture, and an explanation of the client A will be given by way of an example.

Referring to FIG. 3, the client A may be defined as a computer including a CPU 11, a memory 12, an input device 13, a display 14, a communication interface (I/F) 15 and a secondary storage unit 16, which are connected to each other via a bus B2.

The secondary storage unit 16 is recorded with a plurality of programs executed by the CPU 11 and plural items of data used when executing these programs. The plurality of programs include a program for the computer to execute a plurality of processes so as to function as the client A, and programs for actualizing the communication protocols (TCP/IP, HTTP, FTP, SMTP, POP, etc) with the clients A˜D.

Configurations and functions of the memory 12, the input device 13, the display 14 and the communication I/F 15 are the same as those of the memory 2, the input device 3, the display 4 and the communication I/F 5.

The CPU 11 downloads the programs stored in the secondary storage unit 16 into the memory 12, and executes these programs, thereby executing a variety of processes as the client A. The processes executed by the CPU 11 include a process of transmitting to the center system S the data files that should be multicast, a process of transmitting the center system S the information for creating the multicast group, and a process of receiving the data files that have been multicast.

Note that the CPU 11 and the communication I/F 15 correspond to a data transmitting module and a destination information notifying module according to the present invention.

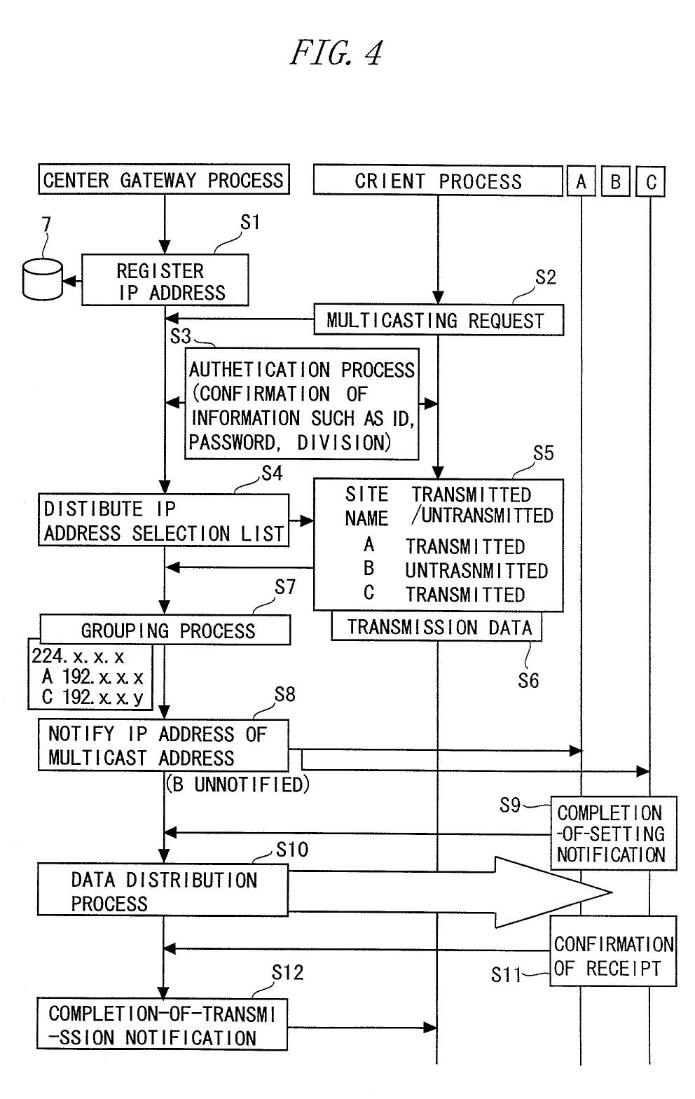

Next, an operational example of the system will be explained referring to FIGS. 1 and 4. FIG. 4 is a sequence diagram showing an operation of the system shown in FIG. 1. Referring to FIG. 4, to start with, the center operator operates the center system and registers the IP addresses (step S1).

More specifically, the center operator inputs to the center system S the IP addresses registerable as the multicast group and pieces of information each unique to each of the IP addresses by manipulating the input device 13. Then, the CPU 11 records the inputted IP addresses and the identifying information on an identification database 7 on the secondary storage unit 6. Thus, the identification database 7 is created.

Thereafter, if any one (assumed to be the client D herein) of the clients A˜D desires to transmit the data stored in the secondary storage unit 16 to the clients A and C, the CPU 11 of the client D transmits a request for multicasting to the center system S (step S2) The multicasting request is sent out of the communication I/F 15 of the client D and received by the center system S via the Intranet.

When the center system S receives the multicasting request, an authentication process is executed between the center system and the client D (step S3). Namely, the center system S transmits to the client Dan input interface for inputting pieces of authentication information such as user's ID, a user's password, a division to which the user belongs, and so on. The input interface is displayed on the display 14 of the client D. The user of the client D inputs the authentication information such as the user's ID, the user's password, etc by use of the input interface. Then, the CPU 11 transmits the inputted authentication information such as the user's ID, the user's password etc to the center system S. The center system S executes a process of collating the authentication information received from the client D by use of collation information stored in the secondary storage unit 6.

If a result of the collation is “OK”, the CPU 11 of the center system S reads a plurality of site names stored in the IP address table 7, then creates an IP address selection list (which will hereinafter be simply referred to as a [list]) containing the read-out site names, and transmits this list to the client D (step S4: see an arrowhead P1 in FIG. 1). Note that if the result of the collation is NG (No Good, which implies invalidity), the center system S makes a request for the authentication information once again. If the number of occurrences of “NG” comes to a predetermined number, the center system S rejects the multicasting request.

The CPU 11 of the client D displays the list received from the center system S on the display 14. The plurality of site names contained in the list are thereby displayed as options of destination of the file. Thus, not the IP address itself but the site name is displayed, whereby the user is able to easily recognize and select the destination. As a matter of course, the IP address itself may also be displayed. What suffices as a list display mode may be such that the user is able to select a plurality of destinations that should be included in the multicast group from a greater plurality of destinations by use of a proper selection method.

The user of the client D refers to the list displayed, and selects a plurality of site names corresponding to the destinations by using the input device 13 (step S5). FIG. 4 shows an example in which the site names (the IP addresses) correspond to the clients A˜C, the sites corresponding to the clients A and C are selected, while the site corresponding to the client B is not selected.

Further, the user specifies the data file that should be multicast by manipulating the input device 13 (step S6). Then, the CPU 11 reads the specified file from the secondary storage unit 16, and transmits to the center system S the readout file and the plurality of site names (corresponding to destination information) selected (see an arrowhead P2 in FIG. 1).

The CPU 1 of the center system S, upon receiving the plurality of sites and the file, stores the file in the data storage module 8. Subsequently, the CPU 1 reads respectively the IP addresses corresponding to the plurality of site names received, and creates the multicast group by allocating multicast IP addresses (which will hereinafter be called [multicast addresses]) to those IP addresses (a grouping process: step S7).

FIG. 4 shows the example of creating the multicast group (of which a multicast address is “224.x.x.x”) consisting of an IP address “192.x.x.x” of the client A and an IP address “1192.x.x.y” of the client C. The thus created multicast group (having the multicast address) is temporarily stored in the memory 2. Thus, according to the present invention, the multicast group is not registered. As a matter of course, the multicast group generated mat be stored and used as the necessity arises.

Next, the CPU 1 of the center system S notifies the destinations defined by the IP addresses belonging to the generated multicast group, of the multicast address stored (step S8). FIG. 4 shows an example in which the clients A and C selected by the user of the client D are notified of the multicast address.

The CPUs 11 of the clients A and C, when receiving the multicast address, make a setting of taking in the IP packets with the multicast address set as a destination address in accordance with an operation of the user. Upon an end of this setting, each of the CPUs 11 notifies the center system S that the setting of taking the multicast address has been completed (step S9).

The CPU 1 of the center system S, when notified of the completion of the setting (a completion-of-setting notification), executes a process of distributing the data (step S10). Namely, the CPU 1 reads from the data storage module 8 the files received from the client D, assembles at least one IP packet stored with this file, and sends the IP packet to the Intranet in a way that destination sets the generated multicast address in the header of this IP packet.

The thus sent IP packet is forwarded to the clients A˜D via the Intranet. Among the clients A˜D, the clients A and C belonging to the multicast group, if the destination address of the IP packet is identical with the notified multicast address, take in this IP packet. By contrast, the clients B and D, because of the destination addresses not being their own IP addresses, do not take in this IP packet. The IP packet is thereby forwarded to only the clients belonging to the multicast group. Thus, the data file from the client D is multicast via the center system S (see an arrowhead P3 in FIG. 1).

The CPUs 11 of the clients A and C, upon taking in all the IP packets, notify the center system S that the receipt of the file has been completed (step S11).

The center system S, when receiving a receipt-of-file notification from each of the clients A and C, transmits a completion-of-transmission notification to the client D. With the processing thus done, the center system S generates the multicast group consisting of the IP addresses selected by the client having made the request for transmitting the file, and multicasts the file to this multicast group. Each of the users of the clients (A and C in the example shown in FIG. 4) to which the file has been multicast, displays contents of the received data file on the display 14 and is thus able to refer to the file.

Note that the clients A˜C are capable of transmitting the multicasting request to the center system S. In this case also, the operation shown in FIG. 4 is carried out, and the center system S multicasts the file received from the request source client to a plurality of destinations selected by this client.

According to the first embodiment, the center system S, when receiving the multicasting request from the client, gives the list to the request source client, and prompts the client to select a plurality of IP addresses (site names) corresponding to the transmission destinations. Then, the center system S generates a multicast group based on a result of this selection.

The user of the request source client is thereby able to select the plurality of destinations as the user intends, to which the file should be multicast. In this case, there is no necessity of requesting the center operator to generate the multicast group as done in the prior art, and hence the user does not come to have this time-consuming operation.

Further, the user is capable of multicasting the information simultaneously to arbitrary destinations with no delay. The user-friendliness is therefore enhanced.

On the other hand, the center system S automatically generates the multicast group based on the result of the address selection, which relieves the center operation from the time-consuming operations such as newly registering the multicast group in response to the request given from the client and changing the contents of the multicast group. Hence, a quantity of the operations by the center operator decreases, thereby reliving the load upon the center operator. Further, it is feasible to restrain a mistake in operation in the center system S.

Moreover, according to the multicast system of the present invention, it is sufficient that only the center system s has the software for multicasting, and the costs can be therefore restrained.

According to the present invention, some of the list providing methods can be selected in terms of the security and the user-friendliness.

A method (1) is that pieces of information on all the users registered are transmitted.

A method (2) is that a range of disclosing the list is narrowed down based on the authentication information obtained when authenticating the user, and the list falling within the narrowed-down range is provided.

The center system S creates the list within the range corresponding t, e.g., the authentication information (on a business office and a division to which the user belongs, a job classification and a post of the user, etc) obtained from, the user, and provides the list to the request source client. The destination to which the file is transmitted can be thereby controlled. Accordingly, it is possible to prevent the information from being multicast to unrelated business offices, divisions, job classifications and posts and from leaking out.

A method (3) is that the user selects the list disclosure range in contrast with the method (2) described above, and the list within the corresponding range is provided.

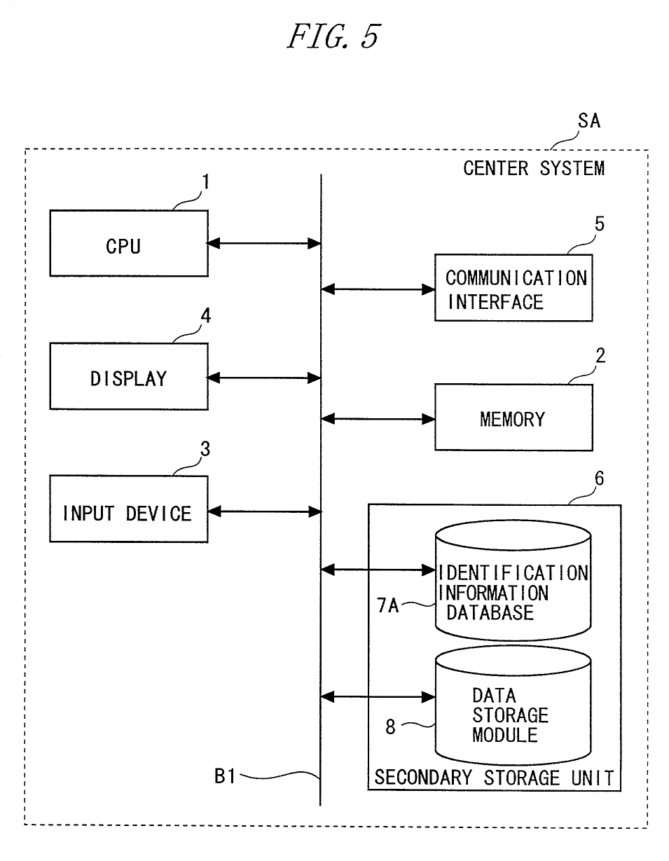

The methods (1)˜(3) explained above are adopted, and hence the system exemplified in the first embodiment may be modified as follows. FIG. 5 is a diagram showing a hardware architecture of a center system SA by way of a modified example. The center system SA is different from the center system S in terms of having an identification information database 7A as a substitute for the IP address table 7 on the secondary storage unit 6.

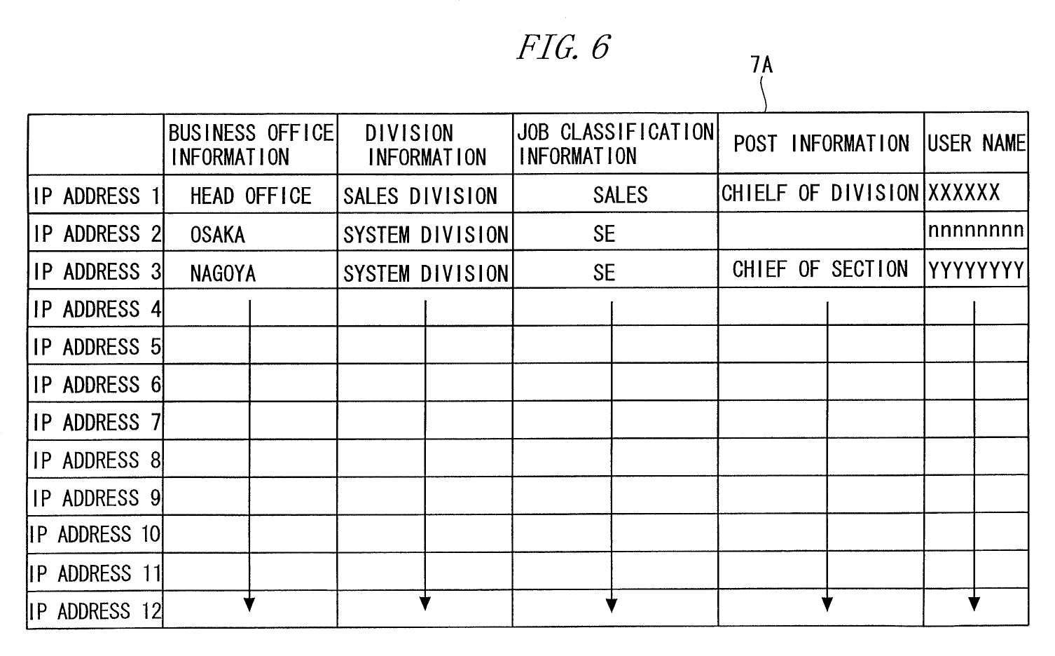

FIG. 6 is an explanatory diagram of the identification information database 7A. The identification information database 7A is stored with a plurality of records each consisting of an IP address and at least one item of identification information unique to this IP address as an IP address-to-identification information mapping. The identification information in this example consists of a name of the user given an IP address (a user name field) and at least one item of attribute information (four items of attributes information such as business office information, division information, job classification information and post information are given in this example) allocated to (characteristic of) this user. The IP address corresponding to a certain item of identification information can be extracted from the identification database 7.

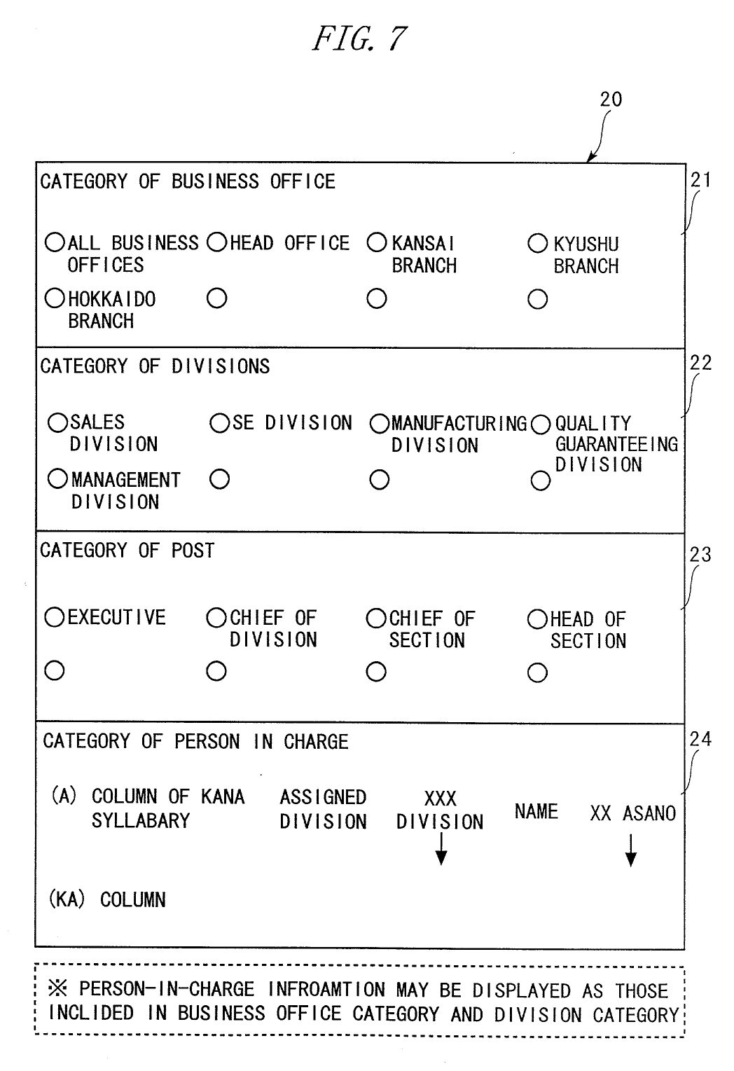

FIG. 7 is a diagram showing a display example of a list screen 20 provided to the request source client. The list screen 20 contains a first list 21 corresponding to the IP address disclosure range [business office], a second list 22 corresponding to the range [division], a third list 23 corresponding to the range [post] and a fourth list 24 corresponding to a range [person in charge] .In this example, the ranges prepared are [business office] , [division] , [post] and [person in charge].

The first list 21 is a list containing all the business offices handled by the enterprise as options (items). The user may select at least one of the plurality of items in the first list 21. If all the items in the first list 21 are selected, all the IP addresses registered in the center system SA are selected.

The second list 22 is a list containing all the divisions (job classifications) handled by the enterprise as options (items). The user may select at least one of the plurality of items in the second list 22. If all the items in the second list 22 are selected, all the IP addresses registered in the center system SA are selected.

The third list 23 is a list containing all the posts in the enterprise as options (items) The user may select at least one of the plurality of items in the third list 23. If all the items in the third list 23 are selected, all the IP addresses registered in the center system SA are selected.

The fourth list 24 is a list containing all the persons in charge who belongs to the enterprise as options (items). The user may select at least one of the plurality of items in the fourth list 24. If all the items in the fourth list 24 are selected, all the IP addresses registered in the center system SA are selected.

When the center system SA receives from the client a selected result (selected item: corresponding to destination information) on the list screen, the CPU 1 of the center system SA reads a plurality of IP addresses corresponding to at least one selected item (destination information) from the identification database 7A. Then, the CPU 1 generates a multicast group consisting of the plurality of readout IP addresses, and multicasts the file to the generated multicast group.

If the list providing method (1) given above in the architecture described above is adopted, the center system SA creates and provides the list screen 20 containing the first through fourth lists 21˜24 shown in FIG. 7. The user is thereby able to select the multicasting destinations by use of the list the user prefers. Thus, the list screen 20 containing the first through fourth lists 21˜24 is provided, and hence the user cal select the multicasting destinations by the selection method the user prefers.

By contrast, in the case of adopting the list providing method (2) given above, the center system SA creates and provides, based on the user attributes (the business office and division to which the user belongs and the job classification ) contained in the authentication information obtained by the authentication process, the list screen 20 on which a predetermined list among the first through fourth lists 21˜24 is deleted, or the list screen 20 on which a predetermined item can not be selected (e.g., the predetermined item is deleted) from the first through fourth lists 21˜24. The multicasting destinations can be thereby controlled.

Further, in the case of adopting the list providing method (3) given above, the center system SA, before providing the list, obtains information for defining the range of the list (which may be called the range information) selected by the user from the request source client. For example, the center system SA obtains the range information together with the authentication information such as the user's ID and password, etc in the authentication process in step S3. At this time, example, the center system SA obtains any one of the ranges [business office], [division], [post] and [person in charge].

The center system SA, when obtaining a result of “OK” in the authentication process, creates the information for the list screen (client screen) corresponding to the range information, and gives the same information to the client having sent the multicasting request.

If the range [business office] is selected, the center system SA creates and provides the list screen 20 containing only the first list 21. Further, if the range [division] is selected, the center system SA creates and provides the list screen 20 containing only the second list 22. If the range [post] is selected, the center system SA creates and provides the list screen 20 containing only the third list 23.

Moreover, if the range [person in charge] is selected, the center system SA creates and provides the list screen 20 containing only the fourth list 24. Instead, the center system SA may create and provide the list screen 20 containing, in addition to the fourth list 24, at least one of the first through third lists 21˜23.

This enables the user to select the range the user prefers and select the multicasting destinations from the list corresponding to the selected range. Further, a list providing method actualized by combining the methods (2) and (3) may also be adopted.

As by the method (2), the list disclosure range is narrowed down in the grouping process for multicasting, whereby the security can easily be managed. Particularly, the security can be strengthened by hierarchizing the list provided to the clients. On the other hand, it is also easy to expand the list disclosure range.

[Second Embodiment]

It is assumed in the first embodiment that the data to be multicast is categorized as the data file A second embodiment is carried out on the assumption that the data are categorized as stream data.

The second embodiment has the architecture common to the first embodiment, and therefore the discussion will focused on only different points. The different points of the second embodiment from the first embodiment are a timing of transmitting the data and a point that the completion-of-receipt notification is not required.

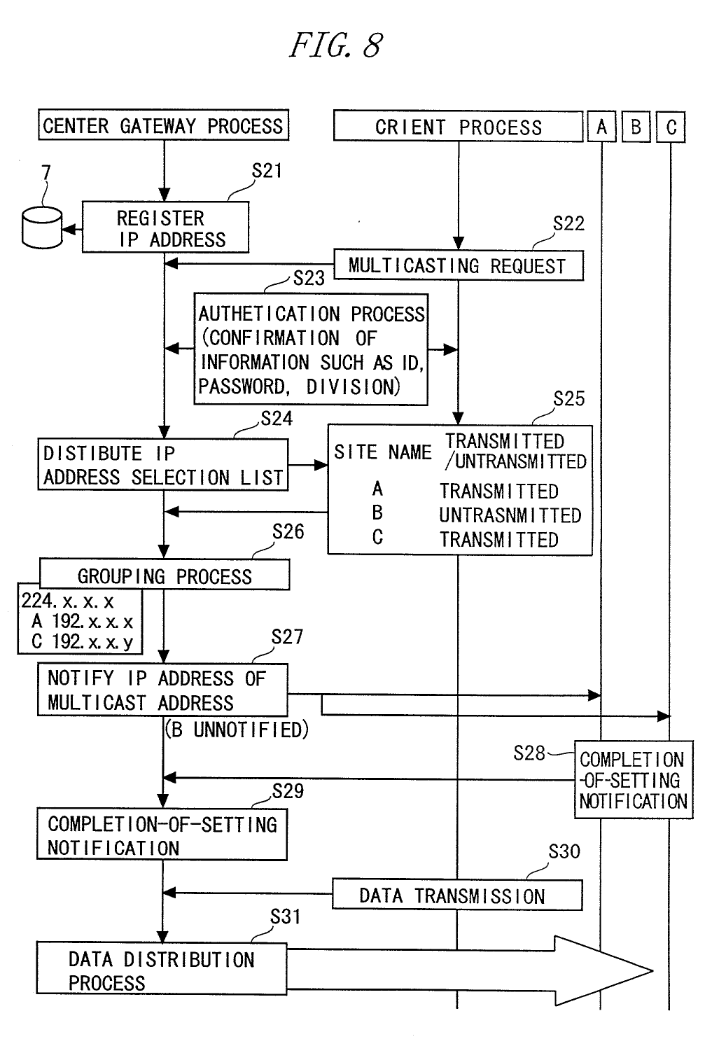

FIG. 8 is a sequence diagram showing an operational example of the system in the second embodiment. Referring to FIG. 8, the center system S executes as a premise an IP address registering process by the same method as in the first embodiment (step S21).

Thereafter, if the client (among the clients A˜D) makes a multicasting request (step S22), the center system S executes the authentication process and checks whether or not the clients are registered as network subscribers (step S23). If the clients are approved, the center system S transmits a list of the IP addresses to the request source client (step S24).

The request source client selects the sites to which the client desires to multicast the stream data from the list, and transmits the selected sites back to the center system S (step S25). The center system S reads from the IP address table 7 a plurality of IP addresses corresponding to the result of selecting the sites, and creates a multicast group formed of the plurality of IP addresses read out (a grouping process: step S26).

After grouping the IP addresses, the center system S notifies the multicast target clients (IP addresses) of the multicast address (step S27). The plurality of corresponding clients set the multicast address, and, upon finishing this setting, notify the center system S of the completion of setting (step S28).

The center system S, when notified of the completion of having set the multicast address from the clients to which the multicast address has been transmitted, notifies the request source client that a get-ready-for receiving operation is well done (step S29).

The request source client, upon receiving the notification from the center system S, transmits to the center system S the stream data that should be multicast (step S30). At this time the request source client continues to transmit till one program (stream data) is ended.

The center system S multicasts the stream data received from the request source client (step S31). Note that the stream data may be received by only those who want to audition as in the case of TV broadcasting and radio broadcasting, and hence the notification of completion is not required to be given.

The second embodiment has the same effects as those of the first embodiment. Further, according to the second embodiment, all the list providing methods and the modified examples thereof explained in the first embodiment can be applied.

[Third Embodiment]

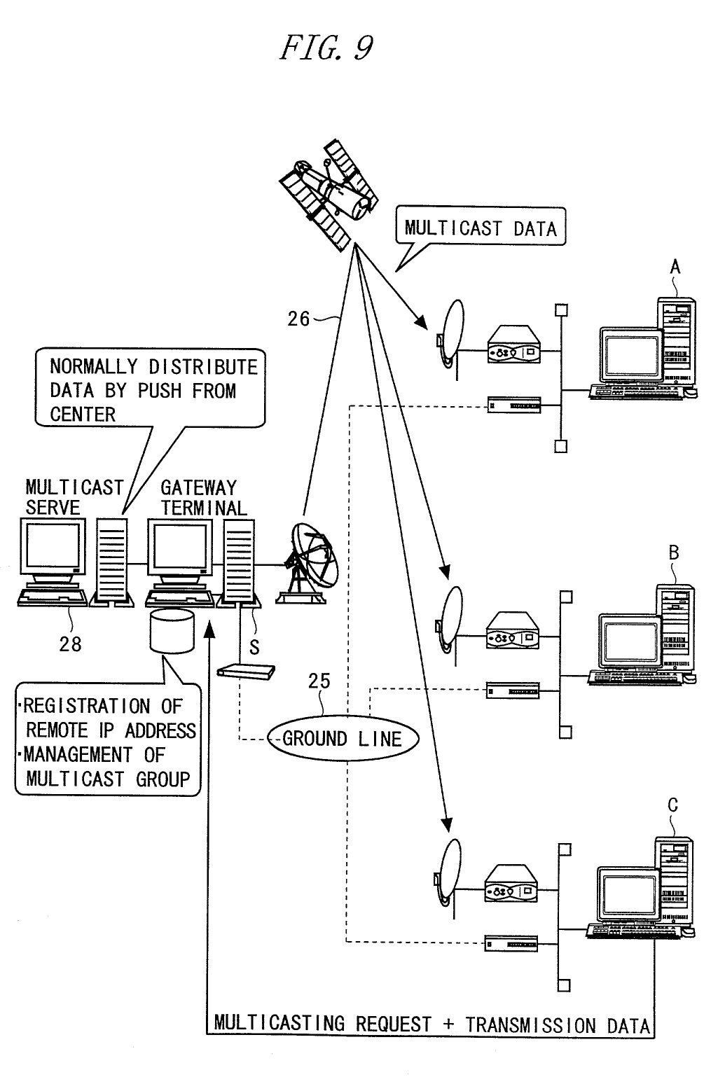

FIG. 9 is a view showing a system architecture in a third embodiment. The third embodiment is exemplification of using a ground line 25 and a satellite link 26 in place of the Intranet used as a network in the first and second embodiments.

The same principle as that of the first and second embodiments is applied. Namely, referring to FIG. 9, the center system S (a gateway terminal) S obtains a plurality of transmitting destinations (destination information) and the data to be multicast from the multicasting request source client by use of the ground line 25 through the same operation as that shown in FIG. 4 or 8. The center system S generates a multicast group on the basis of the destination information, and multicasts the data to the multicast group via the satellite link 26. The data are transmitted to the destinations (clients) corresponding to the multicast addresses. Further, in the example shown in FIG. 9, each of the clients A˜C is capable of controlling the multicast destinations of contents provided to the center system S from a multicast server 28.

According to the third embodiment, the multicast may be defined as a data distribution architecture for simultaneously distributing the data to a plurality of specified destinations, and therefore the network can easily be configured by utilizing a broadcasting property as a characteristic of the satellite link 26.

The first through third embodiments have given the example where the multicasting request source (client) may become the destination to which the data are multicast. According to the present invention, however, it is not AN indispensable requirement that the client becomes the destination to which the multicast data are multicast.

What is claimed is:

1. A multicast system comprising:
a client; and
a center system connected via a network to said client,
said client including:
(A) a data transmission module for transmitting to said center system pieces of data that should be multicast; and
(B) a destination information notifying module for notifying said center system of destination information on a plurality of transmission destinations of the data,
said center system including:
(a) a receiving module for receiving the data and the destination information;
(b) a generating module for generating a multicast group containing the plurality of transmission destinations on the basis of the destination information; and
(c) a multicast module for multicasting the data to the generated multicast group.

2. A multicast system according to claim 1, wherein said center system further includes a list providing module for providing said clients with a list for a user of the client to select a plurality of transmission destinations, and
said destination information notifying module notifies said center system of the destination information on the plurality of transmission destinations selected by the user from the list.

3. A multicast system according to claim 2, wherein said receiving module receives user information from said client, and
said list providing module provides said client with a list containing information on a transmission destination corresponding to the user information among a plurality of transmission destinations to which the data can be multicast.

4. A multicast system according to claim 2, wherein said receiving module receives range information on a range of the transmission destination selected by the user from said client, and
said list providing module provides said client with a list containing information on a transmission destination corresponding to the range information among a plurality of transmission destinations to which the data can be multicast.

5. A multicast group generating method in a multicast system comprising a client, and a center system connected via a network to said clients, said method comprising steps of:
notifying said center system of data that said client desires to multicast and of destination information on a plurality of transmission destinations;
receiving the data and the destination information by said center system; and
generating a multicast group containing the plurality of transmission destinations by said center system.

6. A multicast group generating method according to claim 5, further comprising:
a step of providing said client with a list fur a user of said client to select a plurality of transmission destinations by said center system; and
a step of notifying said center system of the destination information on the plurality of transmission destinations selected out of the list by the user from said client.

7. A multicast group generating method according to claim 6, further comprising:
a step of receiving the user information by said center system from said client; and
a step of providing said client with a list by said center system, the list containing the information on the transmission destination corresponding to the user information among the plurality of transmission destinations to which the data can be multicast.

8. A multicast group generating method according to claim 6, further comprising:
a step of receiving, from said client, range information on a range of the selected-by-the-user transmission destination by said center system; and
a step of providing said client with a list by said center system, the list containing the information on the transmission destination corresponding to the range information among the plurality of transmission destinations to which the data can be multicast.

9. A multicast device comprising:
a receiving module for receiving data that should be multicast and destination information on a plurality of transmission destinations of the data from a client via a network;
a generating module for generating a multicast group containing the plurality of transmission destinations on the basis of the destination information; and
a multicasting module for multicasting the data to the generated multicast group.

10. A multicast device according to claim 9, further comprising a list providing module for providing said client with a list for a user of said client to select a plurality of transmission destinations, and
said destination information notifying module notifies said center system of the destination information on the plurality of transmission destinations selected by the user from the list.

11. A multicast device according to claim 10, wherein said receiving module receives user information from said client, and
said list providing module provides said client with a list containing information on a transmission destination corresponding to the user information among a plurality of transmission destinations to which the data can be multicast.

12. A multicast device according to claim 10, wherein said receiving module receives range information on a range of the transmission destination selected by the user from said client, and
said list providing module provides said client with a list containing information on a transmission destination corresponding to the range information among a plurality of transmission destinations to which the data can be multicast.

13. A multicast device according to claim 9, wherein the data are categorized as a data file.

14. A multicast device according to claim 9, wherein the data are categorized as stream data.

15. A multicast device according to claim 9, wherein said multicasting module multicasts the data via a satellite link.

16. A multicast group generating method in a multicast device for multicasting data to a plurality of multicast groups, said method comprising steps of:
receiving the data that should be multicast and destination information on a plurality of transmission destinations from a client via a network; and
generating the multicast group containing the plurality of transmission destinations on the basis of the destination information.

17. A multicast group generating method according to claim 16, further comprising a step of providing said client with a list for a user of said client to select a plurality of transmission destinations in order to receive the destination information.

18. A multicast group generating method according to claim 17, further comprising step of:
receiving user information from said client; and
providing said client with a list containing information on a transmission destination corresponding to the user information among the plurality of transmission destinations to which the data can be multicast.

19. A multicast group generating method according to claim 17, further comprising steps of:
receiving range information on a range of the transmission destination selected by the user from said client; and
providing said client with a list containing information on a transmission destination corresponding to the range information among the plurality of transmission destinations to which the data can be multicast.
